(19) United States
(12) Patent Application Publication
(10) Pub. No.: US 2025/0176076 A1
(43) Pub. Date: May 29, 2025

(54) DEFOGGING DEVICE

(71) Applicant: TOYOTA JIDOSHA KABUSHIKI KAISHA, Toyota-shi (JP)

(72) Inventor: Shuhei HORIMOTO, Toyota-shi (JP)

(73) Assignee: TOYOTA JIDOSHA KABUSHIKI KAISHA, Toyota-shi (JP)

(21) Appl. No.: 18/801,964

(22) Filed: Aug. 13, 2024

(30) Foreign Application Priority Data
Nov. 27, 2023 (JP) 2023-199923

(51) Int. Cl. H05B 3/86

(52) U.S. Cl. CPC H05B 3/86

(57) ABSTRACT

The defogging device comprises an electrical circuit for heating the window glass. The electrical circuit includes a heating wire disposed on the window glass and a repairing wiring disposed on the window glass. The heating wire includes a first heat generating portion, a second heat generating portion extending from the first heat generating portion, and a third heat generating portion extending from the second heat generating portion. The repairing wiring includes: a first repairing portion provided on a line on the window glass that can bypass the first heat generating portion and the second heat generating portion and having an interrupting portion; and a second repairing portion provided on a line on the window glass that can bypass the second heat generating portion and the third heat generating portion and having an interrupting portion.

### CROSS-REFERENCE TO RELATED APPLICATION

This application claims priority to Japanese Patent Application No. 2023-199923 filed on Nov. 27, 2023, incorporated herein by reference in its entirety.

### BACKGROUND

### 1. Technical Field

The disclosure relates to a defogging device.

### 2. Description of Related Art

WO 2021/246326 discloses a conventional defogging device for automotive window glass. This defogging device for automotive window glass is provided with a heating wire for defogging, made of a single wire, in a camera image-capturing area of a windshield for shooting scenery outside of a vehicle by an in-vehicle camera through the windshield.

### SUMMARY

However, the above-described conventional defogging device for automotive window glass does not take into consideration repairability when line breakage of the heating wire occurs.

The disclosure has been made in view of such problems, and an object thereof is to improve repairability of a defogging device for window glass.

In order to solve the above problems, a defogging device according to an aspect of the disclosure includes an electrical circuit for heating a window glass.

The electrical circuit includes
a heating wire disposed on the window glass, and
repairing wiring disposed on the window glass.

The heating wire includes
a first heat generating portion,
a second heat generating portion extending from the first heat generating portion, and
a third heat generating portion extending from the second heat generating portion.

The repairing wiring includes
a first repairing portion that is provided to a line on the window glass, the line being configured to bypass the first heat generating portion and the second heat generating portion, and that includes an interrupting portion, and
a second repairing portion that is provided to a line on the window glass, the line being configured to bypass the second heat generating portion and the third heat generating portion, and that includes an interrupting portion.

According to these aspects of the disclosure, when line breakage of the heating wire occurs, electricity can be easily applied to the heating wire by electrically connecting both ends of the interrupting portion of the repairing wiring that is provided in advance. Thus, repairability of a defogging device for window glass can be improved.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is a schematic configuration diagram of a windshield glass according to an embodiment of the present disclosure attached to a front surface of a vehicle;

FIG. 2 is a schematic view schematically showing a positional relationship between a windshield glass and an in-vehicle camera;

FIG. 3 is a schematic enlarged view of a windshield glass near a camera imaging area according to an embodiment of the present disclosure;

FIG. 4 is a schematic enlarged view of a windshield glass in the vicinity of a camera imaging area according to an embodiment of the present disclosure, showing a state in which the heating wire is disconnected;

FIG. 5 is a schematic configuration diagram of an electrical circuit of a defogging device according to another embodiment of the present disclosure; and

FIG. 6 is a schematic enlarged view of a windshield glass near a camera imaging area according to another embodiment of the present disclosure.

### DETAILED DESCRIPTION OF EMBODIMENTS

Hereinafter, an embodiment of the disclosure will be described with reference to drawings. In the following description, similar components are given the same reference numbers.

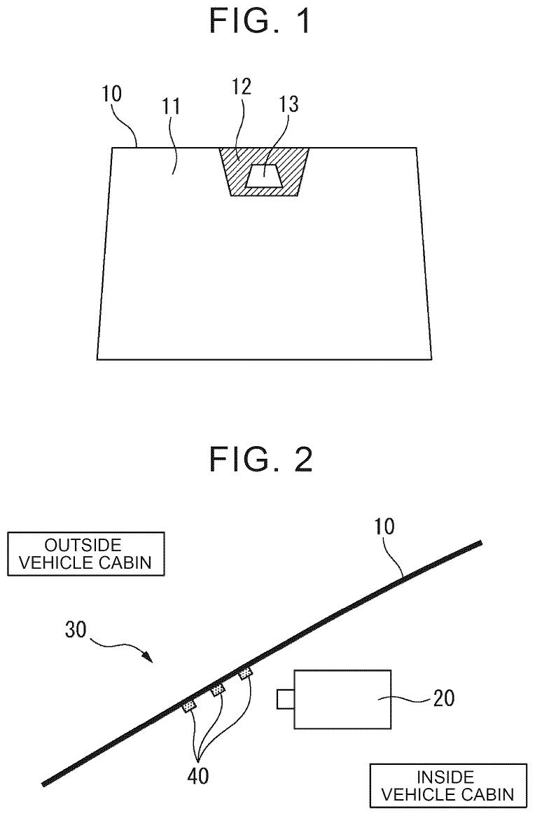

FIG. 1 is a schematic configuration diagram of a windshield glass 10 attached to a front surface of a vehicle. The windshield glass 10 is an example of a window glass. FIG. 2 is a schematic diagram schematically illustrating a positional relationship between the windshield glass 10 and the in-vehicle camera 20.

As illustrated in FIG. 1, the windshield glass 10 includes a transparent transmitting area 11 and a shielding area 12 having a visible light transmittance lower than that of the transmitting area 11. In the present embodiment, the shielding area 12 is formed in the upper central portion of the windshield glass 10.

As illustrated in FIG. 2, the in-vehicle camera 20 disposed in the vehicle captures an image of the outside of the vehicle from the inside of the vehicle via the windshield glass 10. In order to be able to photograph the outside of the vehicle by the in-vehicle camera 20, a transparent camera imaging area 13 is formed in the shielding area 12.

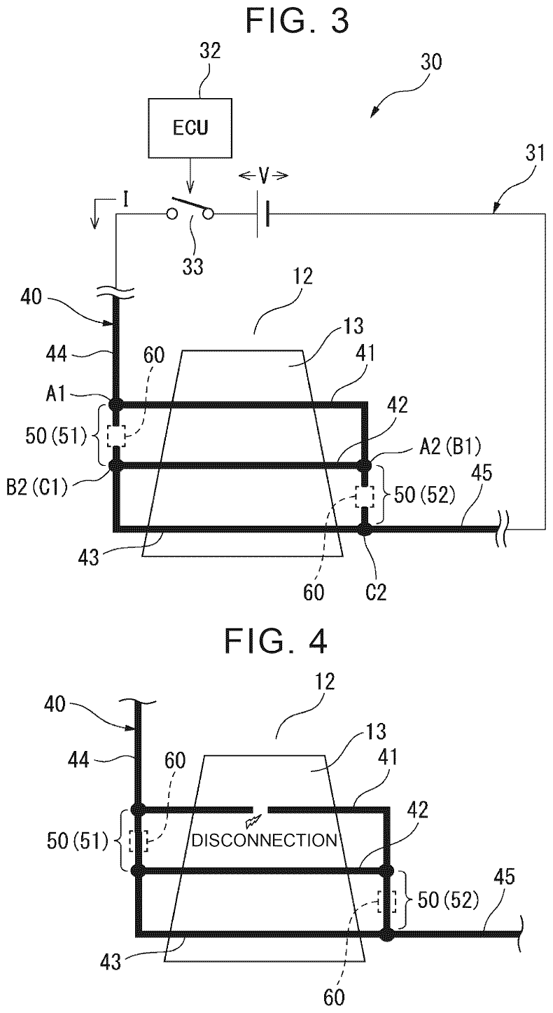

The windshield glass 10 may be clouded due to a temperature difference between the inside and the outside of the vehicle, for example, during a low outside air temperature in winter. When the camera imaging area 13 is cloudy, the outside of the vehicle cannot be photographed by the in-vehicle camera 20. Therefore, in the present embodiment, the defogging device 30 for heating the camera imaging area 13 of the windshield glass 10 is provided. Hereinafter, with reference to FIG. 3, the details of the defogging device 30 according to the present embodiment will be described.

FIG. 3 is a schematic enlarged view of the vicinity of the camera imaging area 13 of the windshield glass 10.

The defogging device 30 includes an electrical circuit 31 that heats the camera imaging area 13 of the windshield glass 10. As shown in FIG. 3, a heating wire 40 constituting a part of the electrical circuit 31 of the defogging device 30 is provided in the camera imaging area 13 of the windshield glass 10 and the shielding area 12 around it. The heating wire 40 is made of a conductor (for example, silver, copper, stainless steel, or the like) that generates heat when energized, and is printed on the surface of the windshield glass 10 in the present embodiment.

The heating wire 40 includes a first heat generating portion 41, a second heat generating portion 42, and a third heat generating portion 43 that heat the camera imaging area 13. At least a part of each of the first heat generating portion 41, the second heat generating portion 42, and the third heat generating portion 43 is disposed in the camera imaging area 13 so as to be able to heat the camera imaging area 13.

The first heat generating portion 41, the second heat generating portion 42, and the third heat generating portion 43 are connected in series. The second heat generating portion 42 extends from the terminal end portion A2 of the first heat generating portion 41 located in the shielding area 12 on the right side in the drawing, and the third heat generating portion 43 extends from the terminal end portion B2 of the second heat generating portion 42 located in the shielding area 12 on the left side in the drawing. The terminal end portion A2 of the first heat generating portion 41 is also the base end portion B1 of the second heat generating portion 42. Similarly, the terminal end portion B2 of the second heat generating portion 42 is also the base end portion C1 of the third heat generating portion 43. The first heat generating portion 41, the second heat generating portion 42, and the third heat generating portion 43 may be configured by a single heating wire 40, or may be configured by connecting a plurality of (for example, three) heating wires 40 in series.

The first resistance portion 44 extends from the base end portion A1 of the first heat generating portion 41 located in the shielding area 12 on the left side in the drawing. Similarly, the second resistance portion 45 extends from the terminal end portion C2 of the third heat generating portion 43 located in the shielding area 12 on the right side in the drawing. Therefore, in the present embodiment, the first resistance portion 44, the first heat generating portion 41, the second heat generating portion 42, the third heat generating portion 43, and the second resistance portion 45 are connected in series.

The first resistance portion 44 is connected to one terminal (in the present embodiment, a positive terminal) of the power supply of the electrical circuit 31 via, for example, an activation switch 33 of the defogging device 30 controlled by the electronic control unit 32. The second resistance portion 45 is connected to the other terminal (negative terminal in the present embodiment) of the power supply of the electrical circuit 31. By bringing the activation switch 33 into a short-circuit state, the heating wire 40 is energized, and the camera imaging area 13 of the windshield glass 10 is heated.

The first resistance portion 44 and the second resistance portion 45 are heating wires in the present embodiment, and are printed on the surface of the windshield glass 10 in the shielding area 12. However, the first resistance portion 44 and the second resistance portion 45 are not limited to the heating wire, and may be a resistor such as a wire harness or a chip resistor, for example. In the case where the first resistance portion 44 is a heating wire, the first resistance portion 44 and the first heat generating portion 41 may be configured by a single heating wire, or a plurality of (for example, two) heating wires may be connected in series between the first resistance portion 44 and the first heat generating portion 41. Similarly, when the second resistance portion 45 is a heating wire, the second resistance portion 45 and the third heat generating portion 43 may be configured by a single heating wire, or may be configured by connecting two heating wires in series.

Here, as in the present embodiment, when the heating wires 40 (that is, the first heat generating portion 41, the second heat generating portion 42, and the third heat generating portion 43) arranged in the camera imaging area 13 are connected in series, if a part of the heating wires are disconnected for some reason, the heating wires 40 cannot be energized. This makes it impossible to heat the camera imaging area 13. Factors include, for example, glass cracking and scraping due to contact of metal or the like with the heating wire 40.

Therefore, when the heating wire 40 is disconnected, replacement of the windshield glass 10 or repair of the disconnected portion is necessary. However, the replacement of the windshield glass 10 is expensive, and the operation itself is not easy. As a method of repairing the disconnected portion, for example, a method of repainting the disconnected portion with an ink material made of silver or the like by manual work may be considered. However, this method has a problem in that it is difficult to reproduce the size of the heating wire 40 (the heating wire width and the heating wire thickness) of the repaired portion in the same manner as in the case of disconnection. The size of the heating wire 40 disposed in the camera imaging area 13 is limited so as not to interfere with the imaging by the in-vehicle camera 20. When the size of the heating wire 40 at the repairing portion becomes larger than that before the disconnection, and the heating wire width and the heating wire thickness of the heating wire 40 at the repairing portion become thicker and thicker, the heating wire 40 is reflected in the captured image of the in-vehicle camera 20. This may interfere with shooting by the in-vehicle camera 20. Further, if the size of the heating wire 40 of the repairing portion becomes larger than that before the disconnection, the repairing portion may be conspicuous from the inside and outside of the vehicle.

Therefore, as shown in FIG. 3, in the present embodiment, a repair heating wire 50 with an interrupting portion 60 for repair is provided in advance in the shielding area 12.

The repair heating wire 50 includes a first repairing portion 51 provided on a line that can bypass the first heat generating portion 41 and the second heat generating portion 42, and a second repairing portion 52 provided on a line that can bypass the second heat generating portion 42 and the third heat generating portion 43.

The line that can bypass the first heat generating portion 41 and the second heat generating portion 42 is a line that can connect the portion of the electrical circuit 31 on the upstream side of the first heat generating portion 41 and the third heat generating portion 43. In the present embodiment, the first repairing portion 51 is provided in a line that connects the base end portion Al of the first heat generating portion 41 and the base end portion C1 of the third heat generating portion 43, which is located in the shielding area 12 on the left side in the drawing.

The line that can bypass the second heat generating portion 42 and the third heat generating portion 43 is a line that can connect the first heat generating portion 41 and a portion of the electrical circuit 31 on the downstream side of the third heat generating portion 43. In the present embodiment, the second repairing portion 52 is provided in a line that connects the terminal end portion A2 of the first heat generating portion 41 and the terminal end portion C2 of the third heat generating portion 43, which is located in the shielding area 12 on the right side in the drawing.

As in the present embodiment, a repair heating wire 50 with an interrupting portion 60 for repair is provided in the shielding area 12 in advance. Thus, for example, as shown in FIG. 4, even if the heating wire 40 disposed in the camera imaging area 13 (in the example shown in FIG. 4, the first heat generating portion 41) is disconnected, by electrically connecting both ends of the interrupting portion 60 of the repair heating wire 50 in the shielding area 12, it is possible to energize the heating wire 40. Therefore, since the repaired portion is within the shielding area 12, the repaired portion does not adversely affect the photographing by the in-vehicle camera 20, and the repaired portion can be made inconspicuous from the inside and outside of the vehicle.

The method of electrically connecting both ends of the interrupting portion 60 of the repair heating wire 50 is not particularly limited, and for example, the interrupting portion 60 may be connected by applying an ink material made of silver or the like as a material, or may be connected by a wire harness. Further, in order to improve the repairability at the time of disconnection, a connector for electrically connecting the interrupting portion 60 may be provided in the interrupting portion 60 in advance.

Here, in the example shown in FIG. 4, the interrupting portions 60 of both the first repairing portion 51 and the second repairing portion 52 are electrically connected, but either one of the interrupting portions 60 may be electrically connected. In a case where the first resistance portion 44, the first heat generating portion 41, the second heat generating portion 42, the third heat generating portion 43, and the second resistance portion 45 are connected in series as in the present embodiment, the resistance values may be set to the same value. As in the example shown in FIG. 4, when the interrupting portions 60 of both the first repairing portion 51 and the second repairing portion 52 are electrically connected, the first heat generating portion 41 before the disconnection, the second heat generating portion 42 and the third heat generating portion 43, and the respective heating values of the second heat generating portion 42 and the third heat generating portion 43 after the repair, it is possible to the same value without changing the applied voltage of the electrical circuit 31 before and after the disconnection. The state before the disconnection is shown in FIG. 3, and the state after the repair is shown in FIG. 4.

It is assumed that the applied voltage of the electrical circuit 31 is V, the current flowing through the electrical circuit 31 is I, resistance values of each of the first resistance portion 44, the first heat generating portion 41, the second heat generating portion 42, the third heat generating portion 43, and the second resistance portion 45 are R, and the respective heat values of the first heat generating portion 41, the second heat generating portion 42, and the third heat generating portion 43 are W1, W2, W3. In the state of FIG. 3 prior to disconnection, since the electrical circuit 31 is a circuit in which five resistors of the resistance value R are connected in series, I=V/5R. Therefore, W1=W2=W3=I²R=V²/25R. On the other hand, in the state of FIG. 4 after the repair, since the electrical circuit 31 is a circuit in which two resistors of the resistance value R are connected in parallel, that is, a circuit in which a resistor of the combined resistance R/2 and the two resistors of the resistance value R are connected in series, I=2V/5R. Therefore, W2=W3=(I/2)²×R=V²/25R. In this case, it is necessary to sufficiently reduce the resistance value of the repair heating wire 50 as compared with the resistance values of the first resistance portion 44, the first heat generating portion 41, the second heat generating portion 42, the third heat generating portion 43, and the second resistance portion 45.

In the present embodiment, the first resistance portion 44, the first heat generating portion 41, the second heat generating portion 42, the third heat generating portion 43, and the second resistance portion 45 are connected in series, but the connection method is not limited thereto. For example, the first resistance portion 44, the second resistance portion 45, the first heat generating portion 41, the second heat generating portion 42, and the third heat generating portion 43 may be connected in series in this order. The first heat generating portion 41, the second heat generating portion 42, the third heat generating portion 43, the first resistance portion 44, and the second resistance portion 45 may be connected in series in this order. Further, the first resistance portion 44 and the second resistance portion 45 may be collectively formed as a resistor having a resistance value 2R, or one or both of the first resistance portion 44 and the second resistance portion 45 may be divided into two or more resistors.

The defogging device 30 according to the present embodiment described above includes an electrical circuit 31 that heats the windshield glass 10 (window glass). The electrical circuit 31 includes a heating wire 40 disposed on the windshield glass 10 and a repair heating wire 50 (repairing wiring) disposed on the windshield glass 10. The heating wire 40 includes a first heat generating portion 41, a second heat generating portion 42 extending from the first heat generating portion 41, and a third heat generating portion 43 extending from the second heat generating portion 42. The repair heating wire 50 includes a first repairing portion 51 and a second repairing portion 52. The first repairing portion 51 is provided in a line on the windshield glass 10 that can bypass the first heat generating portion 41 and the second heat generating portion 42, and has an interrupting portion 60. The second repairing portion 52 is provided in a line on the windshield glass 10 that can bypass the second heat generating portion 42 and the third heat generating portion 43, and has an interrupting portion 60.

Thus, when the heating wire 40 is disconnected, by electrically connecting both ends of the interrupting portion 60 provided in advance, it is possible to easily energize the heating wire 40. Therefore, the repairability of the defogging device 30 of the windshield glass 10 can be improved.

In addition, in the present embodiment, the windshield glass 10 includes a transmitting area 11 in which an image of the outside of the windshield glass 10 is captured by the in-vehicle camera 20 (camera) via the windshield glass 10, and a shielding area 12 having a visible light transmittance lower than that of the transmitting area 11. The heating wire 40 is arranged in the transmitting area 11, and the repair heating wire 50 is arranged in the shielding area 12.

Thus, even if both ends of the interrupting portion 60 are electrically connected, the interrupting portion 60 serving as a repairing portion does not adversely affect photographing by the in-vehicle camera 20, and the interrupting portion 60 serving as a repairing portion can be made inconspicuous from the inside and outside of the vehicle.

Note that a line on the windshield glass 10 that can bypass the first heat generating portion 41 and the second heat generating portion 42 is a line that can connect a portion upstream of the first heat generating portion 41 of the electrical circuit 31 (for example, the first resistance portion 44) and the third heat generating portion 43. A line on the windshield glass 10 that can bypass the second heat generating portion 42 and the third heat generating portion 43 is a line that can connect the first heat generating portion 41 and a portion (for example, the second resistance portion 45) on the downstream side of the third heat generating portion 43 of the electrical circuit 31.

In addition, in the present embodiment, resistance values of portions of the electrical circuit 31 on the upstream side of the first heat generating portion 41, and portions on the downstream side of the first heat generating portion 41, the second heat generating portion 42, the third heat generating portion 43, and the third heat generating portion 43 are identical or substantially identical. The portion on the upstream side of the first heat generating portion 41 is, for example, the first resistance portion 44. The portion on the downstream side of the third heat generating portion 43 is, for example, the second resistance portion 45. Then, the resistance values of each of the repairing portion 51 and the repairing portion 52 when the respective interrupting portions 60 of the first repairing portion 51 and the second repairing portion 52 are electrically connected are smaller than the resistance values of the respective portions upstream of the first heat generating portion 41, the first heat generating portion 41, the second heat generating portion 42, the third heat generating portion 43, and the portions downstream of the third heat generating portion 43. The portion on the upstream side of the first heat generating portion 41 is, for example, the first resistance portion 44. The portion on the downstream side of the third heat generating portion 43 is, for example, the second resistance portion 45.

When any one of the first heat generating portion 41, the second heat generating portion 42, and the third heat generating portion 43 is disconnected, the interrupting portions 60 of both the first repairing portion 51 and the second repairing portion 52 are electrically connected to each other. Thus, the first heat generating portion 41 in front of the disconnection, the heat generation amount of the second heat generating portion 42 and the third heat generating portion 43, the first heat generating portion 41 after the repair, the second heat generating portion 42 and the heat generation amount of the two heat generating portions which are not disconnected among the third heat generating portion 43, it is possible to the same value without changing the applied voltage of the electrical circuit 31 before and after the disconnection. After the repair, that is, after the interrupting portions 60 of both the first repairing portion 51 and the second repairing portion 52 are electrically connected.

Hereinabove, the embodiment of the disclosure has been described. However, the embodiment is merely a portion of application examples of the disclosure and the technical scope of the disclosure is not limited to the specific configurations of the above embodiment.

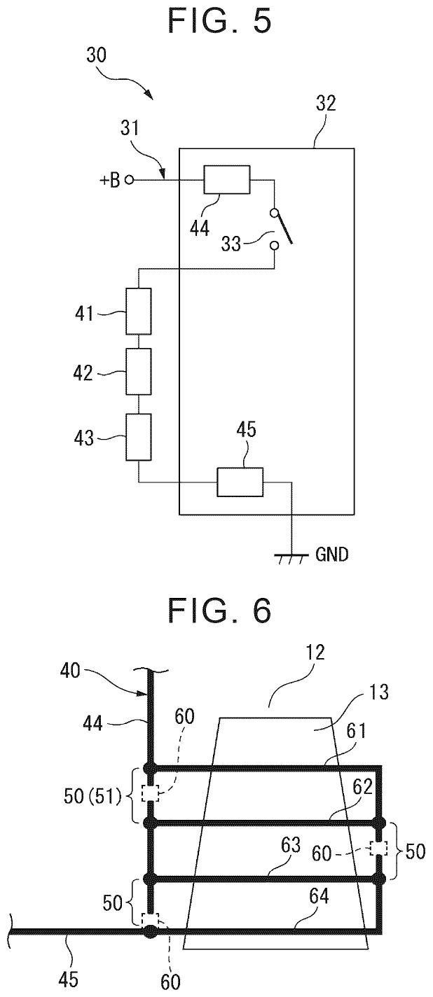

For example, as shown in FIG. 5, the electrical circuit 31 of the defogging device 30 may be configured to include the first resistance portion 44 and the second resistance portion 45 in the electronic control unit 32. In addition, as illustrated in FIG. 6, the heating wire 40 for heating the camera imaging area 13 may connect four heat generating portions 61 to 64 or more heat generating portions in series.

The shielding area 12 may be shielded by painting the glass itself with ceramic or the like, or may be shielded by covering the surface of the window glass with a cover.

What is claimed is:

1. A defogging device comprising an electrical circuit for heating a window glass, wherein:
the electrical circuit includes
a heating wire disposed on the window glass, and
repairing wiring disposed on the window glass;
the heating wire includes
a first heat generating portion,
a second heat generating portion extending from the first heat generating portion, and
a third heat generating portion extending from the second heat generating portion; and
the repairing wiring includes
a first repairing portion that is provided to a line on the window glass, the line being configured to bypass the first heat generating portion and the second heat generating portion, and that includes an interrupting portion, and
a second repairing portion that is provided to a line on the window glass, the line being configured to bypass the second heat generating portion and the third heat generating portion, and that includes an interrupting portion.

2. The defogging device according to claim 1, wherein:
the line on the window glass that is configured to bypass the first heat generating portion and the second heat generating portion is a line that is configured to connect a portion on an upstream side from the first heat generating portion of the electrical circuit, and the third heat generating portion; and
the line on the window glass that is configured to bypass the second heat generating portion and the third heat generating portion is a line that is configured to connect the first heat generating portion, and a portion on a downstream side from the third heat generating portion of the electrical circuit.

3. The defogging device according to claim 2, wherein resistance values of each of the portion on the upstream side from the first heat generating portion, the first heat generating portion, the second heat generating portion, the third heat generating portion, and the portion on the downstream side from the third heat generating portion, of the electrical circuit, are identical or substantially identical.

4. The defogging device according to claim 3, wherein resistance values of each of the first repairing portion when the interrupting portion of the first repairing portion is electrically connected, and the second repairing portion when the interrupting portion of the second repairing portion is electrically connected, are smaller than the resistance values of each of the portion on the upstream side from the first heat generating portion, the first heat generating portion, the second heat generating portion, the third heat generating portion, and the portion on the downstream side from the third heat generating portion.

5. The defogging device according to claim 1, wherein:
the window glass includes a transmitting area through which images of outside of the window glass are shot by a camera through the window glass, and a shielding area with a lower visible light transmittance than that of the transmitting area;
the heating wire is disposed in the transmitting area; and
the repairing wiring is disposed in the shielding area.
